(19) United States
(12) Patent Application Publication
(10) Pub. No.: US 2008/0105617 A1
(43) Pub. Date: May 8, 2008

(54) Two pass reverse osmosis system

(76) Inventor: Eli Oklejas, Monroe, MI (US)

Correspondence Address: HARNESS, DICKEY & PIERCE, P.L.C., P.O. BOX 828, BLOOMFIELD HILLS, MI, 48303, US

(21) Appl. No.: 11/811,607

(22) Filed: Jun. 11, 2007

Related U.S. Application Data
(60) Provisional application No. 60/813,765, filed on Jun. 14, 2006.

(51) Int. Cl. B01D 61/02; B01D 61/08; B01D 61/12

(52) U.S. Cl. 210/637; 210/137; 210/87

(57) ABSTRACT

A reverse osmosis system includes a first membrane chamber having a first feed line and generating a first permeate stream and a first brine stream. The reverse osmosis also includes a feed pump pressurizing the first feed line and a first booster device include communication with the first feed line. A flow balance line is also included in the reverse osmosis system, a second booster device, in fluid communication with the first permeate stream and the flow balance line. The reverse osmosis system also includes a second membrane chamber having a second feed line and fluid communication with the second booster device. The second membrane includes a second permeate stream in fluid communication with the flow balance line.

### CROSS-REFERENCE TO RELATED APPLICATIONS

This application claims the benefit of U.S. Provisional Application No. 60/813,765, filed on Jun. 14, 2006. The disclosure of the above application is incorporated herein by reference.

### TECHNICAL FIELD

The present disclosure relates generally to reverse osmosis systems, and, more specifically, to a two pass reverse osmosis system.

### BACKGROUND

The statements in this section merely provide background information related to the present disclosure and may not constitute prior art.

Reverse osmosis systems are used to provide fresh water from brackish or sea water. A membrane is used that restricts the flow of dissolved solids therethrough.

Referring now to FIG. 1, a reverse osmosis system 10 is illustrated having a first membrane array 12 that generates a permeate stream 14 and a brine stream 16 from a feed stream 18. The feed stream 18 typically includes brackish or sea water. A feed pump 20 coupled to a motor 22 pressurizes the feed stream 18 to the required pressure flow which enters the membrane array 12.

The permeate stream 14 is a purified fluid flow at a low pressure. The brine stream 16 is a high pressure stream that contains dissolved materials blocked by the membrane. The pressure of the brine stream 16 is only slightly lower than the feed stream 18. The membrane array 12 requires an exact flow rate for optimal operation. The flow rate provides a specific pressure for optimization. A brine throttle valve 24 may be used to regulate the flow through the membrane array 12. Changes take place due to water temperatures, salinity, as well as membrane characteristics such as fouling. The membrane array 12 may also be operated at off-design conditions on an emergency basis. The feed pumping system is required to meet variable flow and pressure requirements. A throttle valve 26 may be used to control the feed stream between the feed pump 20 and the membrane 12. The throttle valve 26 thus controls the pressure and flow into the membrane array 12.

The brine throttle control valve 24 drains the brine stream 16 into a drain 30.

The permeate stream 14 passes through a permeate throttle valve 34 which imposes a slight flow resistance even when the valve is completely open. The permeate stream 16 is collected in a buffer tank 38. A fluid level sensor 40 disposed within the tank generates a fluid level signal corresponding to the level of fluid within the buffer tank 38. The fluid level sensor 40 is required to shut down the system when the buffer tank 38 over flows or runs dry. The fluid level sensor signal may control the motor 52.

Permeate from the buffer tank 38 is fluidically coupled to a filter 46 and passes through a second feed pump 50 that is driven by a second feed pump motor 52. A throttle valve 54 receives the fluid from the second feed pump 50. The throttle valve 54 is used to adjust the feed flow and pressure required by the second membrane array 60. Thus, the output of the throttle valve 54 is fluidically coupled to the second membrane array 60. The second membrane array 60 generates a second permeate stream 62 and a second brine stream 64. A second brine throttle valve 66 is used to control the brine flow through the second membrane array 60. The second brine stream 64 from the second brine throttle valve 66 may be coupled to the input of the feed pump 20.

Referring now to FIG. 2, the configuration illustrated is nearly identical to that of FIG. 1 and thus the common elements will not be described. In this configuration, the pump 50 and pump motor 52 are replaced by a booster device 70 having a pump portion 72 and a turbine portion 74. The brine stream 16 is fluidically coupled to the turbine portion 74 and is used to recover energy from the brine stream. In response to the flow of brine fluid, the turbine rotates and thus rotates a common shaft 76 between the pump portion and the turbine portion 74. The common shaft 76, upon rotation, rotates the pump 72 and pressurizes the fluid filtered by the filter 76 from the buffer tank 38. The output fluid from turbine portion 74 is fluidically coupled to a drain 78.

Referring now to FIG. 3, a similar configuration to FIG. 2 is illustrated with the addition of a second booster device 80. In this configuration, fluid from the throttle valve 26 that is pressurized by the pump 20 is received at the pump portion 82 of the second booster device 80. The brine stream 16 is fluidically coupled to the booster device 70 and to the second booster device 80. More specifically, the brine stream 16 is fluidically coupled to the second turbine portion 84 of the second booster device 80. Thus, the energy efficiency from that illustrated at FIG. 2 is improved since the first booster device 70 and the second booster device 80 use the pressurized brine stream 16 to pressurize the system. The output of the turbine portion 84, after much of the energy from the brine stream is removed, is coupled into a drain 88. The spinning of the turbine portion 84 increases the pressure to a second level, higher than that of the feed pump 20 alone.

Referring now to FIG. 4, another configuration similar to FIG. 1 is illustrated. In this configuration, a brine-staged system with a second pass is illustrated. In this embodiment, a third membrane array 90 is illustrated. The third membrane array 90 generates a third permeate stream 92 and a third brine stream 94. A third feed stream 96 receives fluid from the feed pump 20 through the throttle valve 26. In this configuration the third permeate stream 92 and the first permeate stream 14 are provided through the permeate throttle valve 34 into the buffer tank 38.

A pump 98 with a motor 100 receives the brine stream through the brine throttle valve 24 to the feed stream 18 of the first membrane array 12.

In addition, a second permeate throttle valve 102 used to regulate the flow of permeate through the second membrane array 60.

In each of the above embodiments, a large and expensive buffer tank is provided. Each of the embodiments also includes a permeate throttle valve that increases the expensive of a system. Also, the permeate throttle valve provides a source of pressure loss. A filter 46 in each of the embodiments is also used to block debris from the buffer tank from entering the second reverse osmosis membrane array 60. This increases the expense of the system. Safety devices such as the fluid level sensor 40 are used to detect an overflow or detect an empty buffer tank. This also increases the expense of the system and requires controls to regulate the flow rate from the buffer tank to match the flow rate into the buffer tank.

### SUMMARY

The present disclosure provides a system that is capable of adjusting the quality of the output of a multi-stage reverse osmosis system.

In one aspect of the disclosure, a reverse osmosis system includes a first membrane chamber having a first feed line and generating a first permeate stream and a first brine stream. The reverse osmosis also includes a feed pump pressurizing the first feed line and a first booster device include communication with the first feed line. A flow balance line is also included in the reverse osmosis system, a second booster device, in fluid communication with the first permeate stream and the flow balance line. The reverse osmosis system also includes a second membrane chamber having a second feed line and fluid communication with the second booster device. The second membrane includes a second permeate stream in fluid communication with the flow balance line.

In a further aspect of the disclosure, a method of operating a reverse osmosis system with a first membrane chamber having a first feed line, a second membrane chamber having a second feed line, and a flow balance line includes pressurizing the first feed line, generating a first permeate stream and a first brine stream from the first membrane chamber, boosting a pressure in the first feed line with a booster device, generating a second permeate stream and a second brine stream from the second membrane chamber, fluidically coupling a second booster device with the first permeate stream and the flow balance line, fluidically coupling the second feed line with the second booster device, and fluidically coupling the second permeate stream in fluid communication with the flow balance line.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of a first configuration of a two-pass reverse osmosis system formed according to the prior art.

FIG. 2 is a schematic view of a second configuration of a two-pass reverse osmosis system formed according to the prior art.

FIG. 3 is a schematic view of a third configuration of a two-pass reverse osmosis system formed according to the prior art.

FIG. 4 is a schematic view of a fourth configuration of a two-pass reverse osmosis system formed according to the prior art.

FIG. 5 is a schematic view of a two-pass reverse osmosis system formed according to a first embodiment of the present disclosure.

FIG. 6 is a schematic view of a second embodiment of a reverse osmosis system formed according to a second embodiment of the present disclosure.

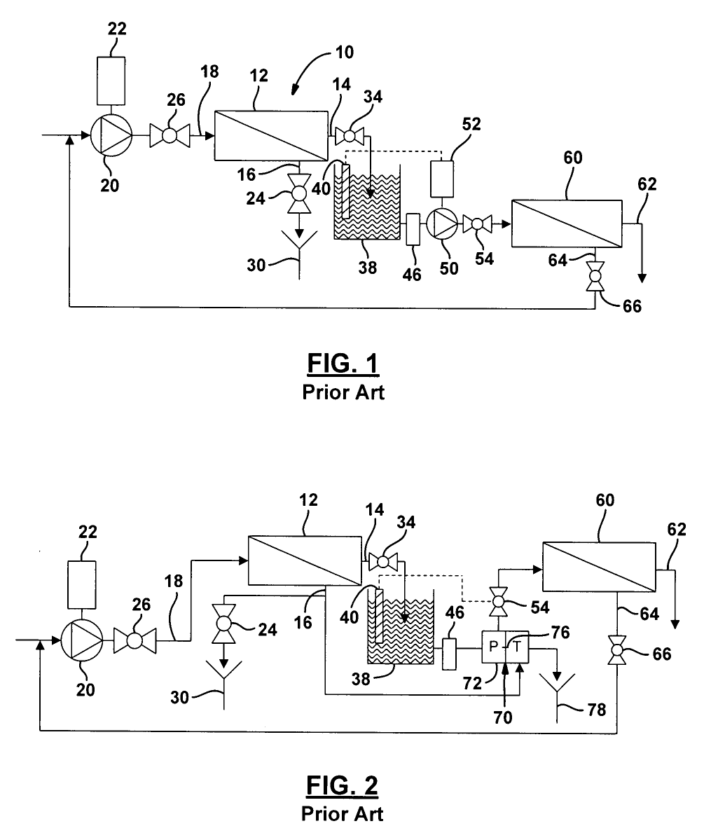

### DETAILED DESCRIPTION

The following description is merely exemplary in nature and is not intended to limit the present disclosure, application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

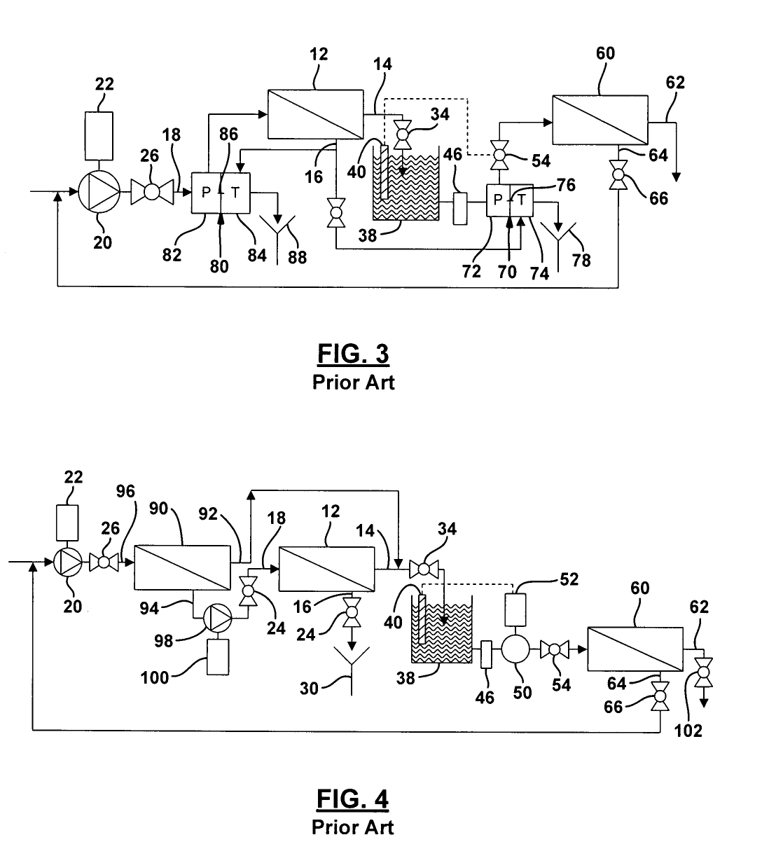

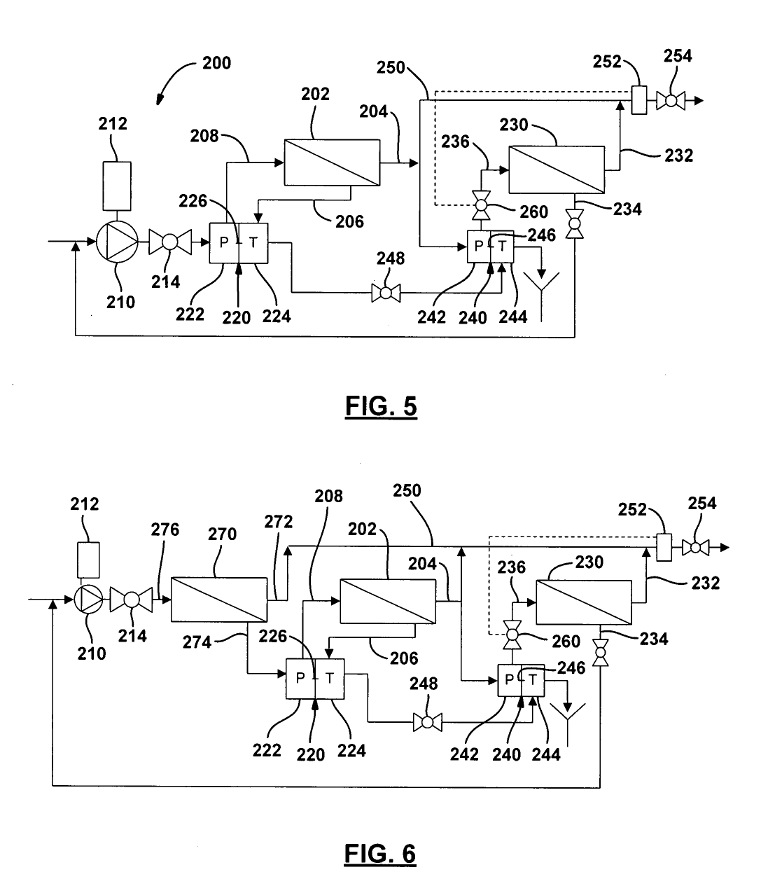

Referring now to FIG. 5, an embodiment having two booster devices is illustrated with the removal of the buffer tank illustrated in FIG. 3. In this embodiment, a reverse osmosis system 200 is illustrated with a first membrane array 202 that generates a first permeate stream 204 and a first brine stream 206. The first permeate stream 204 and the first brine stream 206 are generated from a first feed stream 208. The feed stream 208 is pressurized by two sources that include a feed pump 210 driven by a motor 212.

A feed throttle valve 214 receives the pressurized fluid from the pump 210 and provides the fluid to a first booster device 220. The booster device 220 may be a pump or a pump and turbine. In this figure, the first booster device 220 includes a pump portion 222 and a turbine portion 224. The highly pressurized brine stream 206 is used to drive the turbine portion 224. A common shaft 226 extends between the turbine portion 224 and the pump portion 222 so that upon rotation of the turbine portion, the pump portion pressurizes the fluid in the feed stream in addition to the pressure provided by the pump 210. The feed throttle valve 214 is adjusted to provide the desired flow and pressure into the feed stream of the first membrane array 202.

The reverse osmosis system 200 also includes a second membrane array 230. The second membrane array 230 generates a second permeate stream 232 and a second brine stream 234. The second permeate stream 232 and the second brine stream 234 are generated from a second feed stream 236. The second feed stream 236 has at least a portion of the first permeate stream 204.

The first permeate stream 204 is fluidically coupled to a second booster device 240 that includes a second pump portion 242 and a second turbine portion 244. A common shaft 246 couples the pump portion 242 and the turbine portion 244. The first permeate stream 204 is fluidically coupled to the pump portion 242. The second turbine portion 244 is fluidically coupled to the first turbine portion 224 through a control valve 248 used to control flow therebetween.

The first permeate stream 204 is also coupled to a flow balance line 250. The flow balance line 250 may include a quality meter 252 and a control valve 254. The quality meter 252 may be a permeate TDS meter that is used to generate a quality signal. The TDS meter measures the total dissolved solids (TDS) within the permeate stream and generates a quality signal. The quality signal may be a digital or analog signal.

Another control valve 260 is disposed between the pump portion 242 within the second feed stream 236. The control valve 260 receives the quality signal from the quality meter 242 and is controlled thereby. The valve 260 may be opened when the quality of the permeate signal becomes poor. This allows more permeate to flow through the pump portion 242 and into the second membrane array 230. The permeate from the first membrane array 202 is thus double processed in the second membrane array 230. When the flow through the second membrane array 230 is increased, more permeate is generated in the second permeate stream 232. It is possible that some of the permeate from the second membrane 230 may pass through the flow balance line 250 back into the second booster device 240. This results in further purification. This takes place when not enough permeate is generated by the first membrane 202 as the control valve 60 is opened. One advantage of this embodiment over the prior systems is that if the flow into the second booster device 240 is less than the permeate flow from the first membrane array 202, excess flow from the flow balance line 250 will pass through the discharge valve 254. Conversely, if the flow rate into the booster device 240 is greater than the flow of permeate from the first membrane array 202, then some of the permeate from the second permeate stream 232 will flow through the flow balance line 250 and into the pump portion 242 of the second booster device 240. Thus, the possibility of the pump portion 242 being starved for flow or being unable to handle the flow from the permeate stream 204 is not a possibility since the flow balance line 250 compensates for variations in permeate flow.

It should be noted that in the above embodiment that either or both of the turbo boosters may be replaced with a conventional pump and motor. When using pumps, some of the energy efficiency may be lost.

Referring now to FIG. 6, a similar system to that described in FIG. 5, above, is illustrated. In this embodiment, a third membrane array generating a third permeate stream 272 and a third brine stream 274 is illustrated. The third permeate stream 272 and the third brine stream 274 are generated from a third feed stream 276. The third feed stream 276 is pressurized by the pump 210 and the motor 212 illustrated in FIG. 5. The brine stream 274 of the third membrane array 270 is coupled to the pump portion 222 of the first booster device 220. In this embodiment, the flow balance line 250 receives the permeate stream 272 from the third membrane 270 in addition to the permeate stream 204 from the first membrane array 202. In this embodiment, both the permeate of the third membrane 270 and the second membrane 230 discharge into the flow balance line 250. The permeate stream of the first membrane array 202 discharges both into the flow balance line 250 and into the second pump portion 242.

In this embodiment, the lowest quality permeate is produced by the first membrane array 202. The next lowest quality permeate is produced by the third membrane array 270. The purpose of the second pass membrane 230 is to raise the average quality of the permeate existing in the system. The second membrane 230 preferably receives the lowest quality permeate since purification of the permeate would result in the greatest impact on the overall permeate quality. By minimizing the volume of permeate needed to be handled by the second membrane array, the size of the membrane, the feed pump for turbo-booster associated with the equipment may be minimized. Also, the energy consumption of the second pass feed pump is reduced due to reduced volume of fluid that is required to be pressurized.

In this embodiment, a control signal from the quality meter 252 regulates the control valve 260. When the quality of the permeate is too high, the control valve 260 opens and permits additional flow of permeate 204 into the pump portion 242. To reach the desired level of average permeate, the control valve may continue to open until the entire permeate flow from the first membrane array 202 reaches the second membrane array 230. It should be noted that the second membrane 230 automatically receives the permeate from the first membrane array 202, which is the least quality permeate. Thus, quality is likely to be increased using the second membrane array 230. However, if the average permeate quality is still too low, the control valve 260, when fully opened, may not have enough flow from the permeate stream 204 alone. The flow balance line 250 may thus provide fluid flow in addition to the permeate stream 204. Both the permeate stream 272 from the third membrane array 270 and the second membrane array 202 may be provided to the pump portion 242. The combination of fluids may then be provided to the second membrane array 230.

It should be noted that the piping arrangement illustrated in FIG. 6 allows the second membrane 230 to handle only the first membrane permeate 202 which is of the lowest quality. Then, if necessary, an increasing proportion of the permeate stream 204 from the third membrane may be passed to the second membrane 230. This increases the quality of the system and thus the membrane 230 is automatically optimized for membrane performance.

It should also be noted that the turbo-boosters 240 and 220 may be replaced by pumps driven by a motor. This may reduce the efficiency of the system. In addition, the control valve 260 and the booster 240 may be replaced by a pump capable of generating variable pressure and variable flow in response to the control signal from the permeate quality meter 252.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A reverse osmosis system comprising
a first membrane chamber having a first feed line and generating a first permeate stream and a first brine stream;
a feed pump pressurizing the first feed line;
a first booster device in fluid communication with the first feed line;
a flow balance line;
a second booster device in fluid communication with the first permeate stream and the flow balance line; and
a second membrane chamber having a second feed line in fluid communication with the second booster device, said second membrane comprising a second permeate stream in fluid communication with the flow balance line, said second membrane generating a second brine stream.

2. A reverse osmosis system as recited in claim 1 wherein the first booster device comprises a first pump.

3. A reverse osmosis system as recited in claim 1 wherein the second booster device comprises a second pump.

4. A reverse osmosis system as recited in claim 3 wherein the second booster generates a variable pressure and flow.

5. A reverse osmosis system as recited in claim 1 further comprising a throttle valve disposed within the second feed line.

6. A reverse osmosis system as recited in claim 1 wherein the flow balance line comprises a permeate quality sensor generating a quality signal.

7. A reverse osmosis system as recited in claim 6 wherein the second booster device generates a variable pressure and flow in response to the quality signal.

8. A reverse osmosis system as recited in claim 6 wherein the permeate quality sensor comprises a total dissolved solids meter.

9. A reverse osmosis system as recited in claim 1 further comprising a brine throttle valve disposed within a second brine stream from the second membrane chamber.

10. A reverse osmosis system as recited in claim 1 further comprising a throttle feed valve coupled within the first feed line.

11. A reverse osmosis system as recited in claim 1 further comprising a third membrane having a third feed line, a third brine stream and a third permeate stream, said third brine stream in fluid communication with the first booster device, and said third permeate stream in fluid communication with the flow balance line.

12. A reverse osmosis system as recited in claim 1 wherein the first booster device comprises a first turbine portion and a first pump portion and the second booster device comprises a second turbine portion and a second pump portion.

13. A reverse osmosis system as recited in claim 12 wherein the first turbine portion is in fluid communication with the first brine stream and the first pump portion is in fluid communication with the first feed line.

14. A reverse osmosis system as recited in claim 13 wherein the second turbine portion in fluid communication with first turbine portion, and the second pump portion in fluid communication with the first permeate stream and the flow balance line.

15. A reverse osmosis system as recited in claim 14 wherein the second feed line is in fluid communication with the second pump portion.

16. A reverse osmosis system as recited in claim 15 further comprising a third membrane having a third feed line, a third brine stream and a third permeate stream, said third brine stream is in fluid communication with the first pump portion and said third permeate stream in fluid communication with the flow balance line.

17. A method of operating a reverse osmosis system with a first membrane chamber having a first feed line, a second membrane chamber having a second feed line, and a flow balance line comprising:
pressurizing the first feed line;
generating a first permeate stream and a first brine stream from the first membrane chamber;
boosting a pressure in the first feed line with a booster device;
generating a second permeate stream and a second brine stream from the second membrane chamber;
fluidically coupling a second booster device with the first permeate stream and the flow balance line;
fluidically coupling the second feed line with the second booster device; and
fluidically coupling the second permeate stream in fluid communication with the flow balance line.

18. A method as recited in claim 17 wherein the first booster device comprises a first pump.

19. A method as recited in claim 18 wherein the second booster device comprises a second pump.

20. A method as recited in claim 19 further comprising generating a variable pressure and flow at the second pump.

21. A method as recited in claim 17 further comprising generating a quality signal corresponding to the quality of permeate in the flow balance line.

22. A method as recited in claim 21 further comprising generating a variable pressure and flow in response to the quality signal at the second booster device.

23. A method as recited in claim 21 further comprising controlling a throttle valve within the second feed line in response to the quality signal.

24. A method as recited in claim 21 further comprising providing a third membrane having a third feed line, a third brine stream and a third permeate stream, fluidically coupling said third brine stream with the first booster device, and fluidically coupling said third permeate stream with the flow balance line.

25. A method as recited in claim 24 wherein the first booster device comprises a first turbine portion and a first pump portion and the second booster device comprises a second turbine portion and a second pump portion.

26. A method as recited in claim 25 further comprising fluidically coupling the first turbine portion and the first brine stream and the first pump portion with the first feed line.

27. A method as recited in claim 25 further comprising fluidically coupling the second turbine portion and first turbine portion, and fluidically coupling the second pump portion, the first permeate stream and the flow balance line.

28. A method as recited in claim 27 further comprising fluidically coupling the second feed line and the second pump portion.

29. A method as recited in claim 27 further comprising a third membrane having a third feed line, a third brine stream and a third permeate stream, and fluidically coupling said third brine stream with the first pump portion and fluidically coupling said third permeate stream with the flow balance line.

30. A method as recited in claim 29 further comprising coupling at least a portion of the third permeate stream to the second pump portion.
